(19) United States
(12) Patent Application Publication
(10) Pub. No.: US 2026/0146134 A1
(43) Pub. Date: May 28, 2026

(54) PRECERAMIC SHORT CHAINED POLYMERS AND METHODS THEREOF

(71) Applicant: University of Maryland, College Park, College Park, MD (US)

(72) Inventors: Shenqiang Ren, College Park, MD (US); Saurabh Khuje, College Park, MD (US)

(21) Appl. No.: 19/395,901

(22) Filed: Nov. 20, 2025

Related U.S. Application Data
(60) Provisional application No. 63/724,247, filed on Nov. 22, 2024.

(51) Int. Cl. C08G 77/60; C04B 35/58

(52) U.S. Cl. CPC C08G 77/60; C04B 35/58078; C04B 2235/483; C04B 2235/486

(57) ABSTRACT

The present disclosure generally relates to preceramic precursors for ultrahigh temperature ceramics, for thermal protection systems, and passivation coating.

### CROSS REFERENCE TO RELATED APPLICATIONS

This application claims priority to U.S. Application No. 63/724,247, filed on Nov. 22, 2024, the contents of which are hereby incorporated by reference in its entirety.

### STATEMENT OF FEDERALLY SPONSORED RESEARCH AND DEVELOPMENT

This invention was made with government support under W911NF-25-2-0056 awarded by the Army Research Laboratory-Army Research Office. The government has certain rights in the invention.

### FIELD OF THE INVENTION

The present invention generally relates to preceramic precursors for ultrahigh temperature ceramics, for thermal protection systems, and passivation coating.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Ceramics from chemically distinct preceramic polymer precursors offer unique shaping and microstructural control, but suffer from issues like shrinkage, uncontrolled porosity, and pyrolysis-sensitive stoichiometry. Despite the promising high-temperature properties of compositionally complex ceramics, their full potential is limited by the scarcity of suitable precursors and the low-throughput nature of pyrolysis. The complexity of multiple ceramic species and compositional disorder further complicates phase transitions, and progress is hindered by a lack of high-throughput methods. There is a need for new pathways to develop preceramic polymer-derived ultrahigh temperature ceramics capable of withstanding extreme operating temperatures.

Pre-ceramic polymers, a fusion of synthetic chemistry and ceramic engineering, offer a unique avenue for producing robust ceramics suited for extreme environments. Traditionally, pre-ceramic materials are confined to silicon-based polymers undergoing pyrolysis-induced shrinkage. The vast number of possible combinations, driven by the search for multi-element ceramics with specific properties, renders an Edisonian approach impractical for high-throughput discovery. A hybrid preceramic liquid precursor, synthesized through crosslinking between preceramic polymers and inorganic chemistry, broadening the spectrum of compositions for enhanced high temperature oxidation resistance. Utilizing poly(dimethylsilane) with transition metal elements from groups 4-6 (Zr, Cr, Hf, Mo, V and W), the resulting multi-element oxycarbon-boride ceramics can be additively manufactured and flash-sintered in ˜ 10-30 s under atmospheric conditions is disclosed herein. This high-throughput process yields a crack-free, dense ceramic exhibiting high temperature stability for the metallic base layer up to 1422K. This approach represents a new pathway for developing preceramic polymer-derived ultrahigh temperature ceramics capable of withstanding extreme operating temperatures.

### BRIEF DESCRIPTION OF FIGURES

The patent or application file contains at least one drawing executed in color. Copies of this patent or patent application publication with color drawing(s) will be provided by the Office upon request and payment of the necessary fee. The following drawings form part of the present specification and are included to further demonstrate certain aspects of the present invention. The invention may be better understood by reference to one or more of these drawings in combination with the detailed description of specific embodiments presented herein.

FIG. 1 Schematic process for multi-element ceramic material discovery. FIG. 1a. Process illustrating the approach for the synthesis of a transition metal-crosslinked monomer towards formation of a single source high-throughput preceramic polymer precursor. Table depicting transition metals (in red) that can be utilized for this purpose. FIG. 1b. Formed ceramics being subjected to oxygen-hydrogen torch with the ceramic coating stable under 1422 K. FIG. 1c. Process depicting the conventional approach towards synthesis of polymer-derived ceramics for comparison. FIG. 1d. Ashby plot depicting the characteristic density as a consequence of different pyrolysis temperatures for different techniques. FIG. 1E presents a radar chart that compares key performance metrics, such as pyrolysis temperature, pyrolysis duration, extrusion-based processability, crosslinker tunability, ceramic yield, and operational temperature for thermal management, between the PDCs developed in this study and those reported in the literature. Notably, the ceramics produced in this work demonstrate enhanced ceramic yield, improved extrusion-driven shape control, customizable crosslinker options, rapid pyrolysis capability, and robust oxidation resistance at elevated operating temperatures.

FIG. 2 Characteristics of preceramic polymer prior to addition of filler particles. FIG. 2a. Optical image of the Zr-PDM starting material prior to cross-linking. Inset: SEM observation of segregate ZrCl₄-PDM particles. FIG. 2b. EDS mapping of segregated ZrCl₄-PDM particles. FIG. 2c. Optical image of the Zr—PCS following cross-linking. Inset: SEM observation of a cluster of Zr—PCS particles. FIG. 2d. EDS mapping of crosslinked Zr—PCS cluster. FIG. 2e. Optical image of the Zr—Si—O—C—B precursor following addition of filler particles. Inset: (top) Plot depicting the ceramic yield corresponding to different processing temperatures. (bottom) SEM of a cluster of Zr—Si—O—C—B powder. FIG. 2f. EDS mapping of Zr—Si—O—C—B powder indicative of homogenous distribution of elements. FIG. 2g. FTIR for pure PDM powder, Zr-PDM prior to crosslinking and Zr—PCS crosslinked after thermal curing. FIG. 2h. Heat map illustrating the results of the screening study for determining the optimum ratio for preceramic powder and solvent. FIG. 2i. Plot depicting the pyrolysis temperature-dependent XRD for Zr—Si—O—C—B powders.

FIG. 3 TEM characterization of Zr—Si—O—C—B preceramic precursor. FIG. 3a. Low magnification STEM image. FIG. 3b. Dark field STEM image of a cluster of Zr—Si—O—C—B particles. FIG. 3c. EDS analysis showing the spatial distribution of Zr, Si, O, C, and B within the ceramic precursor, highlighting elemental dispersion and indicating the uniformity and phase interactions in the ceramic matrix. FIG. 3d. HR-TEM image of the Zr—Si—O—C—B preceramic precursor signifying a core-shell structure. FIG. 3e. HR-TEM image showing ZrB₂ particles encapsulated by a crystalline graphitic carbon layer, revealing the core-shell structure and the ordered carbon phase. FIG. 3f. HR-TEM analysis revealing lattice fringes of ZrB₂, highlighting the (002) planes with an interplanar spacing of 3.54 Å, indicating preserved crystalline order in the ZrB₂ phase.

FIG. 4 Additive manufacturing and flash pyrolysis of preceramic precursors to form ceramics. FIG. 4a. Scheme depicting the additive manufacturing (left) and optical image of the preceramic slurry (right). Scheme depicting the electrical pyrolysis process for fabricating ceramics (bottom). FIG. 4b. Temperature-time profile for electrical pyrolysis durations with copper layer. Inset: Optical image of the sample during electrical pyrolysis with tantalum metal foil. FIG. 4c. Plot depicting the power-dependent electrical pyrolysis XRD for printed ceramics. FIG. 4d. SEM observation of the cross-section of electrically pyrolyzed sample at 1073 K. FIG. 4e. SEM observation of the plane view of sample electrically pyrolyzed at 1073 K. FIG. 4f. Plot depicting the resulting density as a result of increasing pyrolysis temperature for fabricated ceramics.

FIG. 5 Evaluation of formed ceramic structures for high temperature stability. FIG. 5a. Optical images of ceramic coated copper geometries (1-D, 2-D, and 3-D) for potential high temperature thermal management applications. FIG. 5b. Ceramic-coated copper foam being subjected to oxygen-hydrogen flame with no significant change to the surface (top). IR image captured by means of a thermographic camera for the ceramic coated Cu-foam subjected to oxygen-hydrogen torch (bottom). FIG. 5c. SEM observations of ceramic coated Cu-foam before and after torch testing (top). Corresponding XRD plot elucidating the crystallographic structure for ceramic coated copper before and after torch testing (bottom). FIG. 5d. Optical image of the high temperature setup for determination of oxidation stability of ceramic coated tantalum foil (top). Scheme depicting the testing mechanism for oxidation and corrosion resistant extreme environment electronics with ceramic coats for thermal management (bottom). FIG. 5e. Planar view SEM observation of the ceramic sample exposed to a temperature of 1873 K under atmospheric conditions for a duration of 5 minutes on tantalum foil. FIG. 5f. EDS mapping of the ceramic sample exposed to a temperature of 1873 K under atmospheric conditions for a duration of 5 minutes (top) and 30 minutes (bottom).

FIG. 6 Optical images for multi-element ceramic powders after thermal curing for crosslinking purposes. FIG. 6a. Chromium (III) chloride as the crosslinker. FIG. 6b. Tungstosilicic acid hydrate as the crosslinker. FIG. 6c. Molybdenum trioxide as the crosslinker. FIG. 6d. Vanadium (III) chloride as the crosslinked metal.

FIG. 7 EDS mapping of preceramic precursor with multiple transition elements as the starting precursor.

FIG. 8 I-V characteristics of ZrB₂ sample prepared using ultra high temperature sintering.

FIG. 9 XRD plots for Zr—PCS preceramic powders pyrolysed at elevated temperatures with different fillers. FIG. 9a. With HfB₂ as a filler. FIG. 9b. With NbC as a filler. FIG. 9c. With TaC as a filler. FIG. 9d. With TiB₂ as a filler.

FIG. 10 FIG. 10a. TEM observation of Zr—Si—O—C—B particles. FIG. 10b. TEM-EDS mapping depicting element distribution.

FIG. 11 FTIR for pure additional transition metals following crosslinking reaction with PCS facilitated by thermal curing. FIG. 11a. Chromium based preceramic precursor. FIG. 11b. Molybdenum based preceramic precursor. FIG. 11c. Tungsten based preceramic precursor.

FIG. 12 Low and high magnification TEM images for Zr—Si—O—C—B particles for particle size and distribution.

FIG. 13 Additional SEM images depicting the cross-section of electrically pyrolyzed Zr—Si—O—C—B sample.

FIG. 14 Plane and isometric images of coated foam as observed via an optical microscope.

FIG. 15 Optical image of the pressed preceramic feedstock powder followed by electrical pyrolysis to obtain a bulk Zr—Si—O—C—B pellet.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “degradable polymeric product” as used herein refers to a polymeric product that degrades in the presence of peroxide (e.g., hydrogen peroxide).

The term “polymer derived ceramics” as used herein refers to advanced ceramics made from preceramic polymers that are pyrolyzed, usually in an inert atmosphere.

The term “additive manufacturing” as used herein refers to 3d printing for rapid prototyping of materials

The term “ceramic particle solid” as used herein refers to ceramic powder solid.

The term “metal particle solid” as used herein refers to transition metal contained materials.

The term “preceramic monomer” as used herein refers to short-chain molecular preceramic precursor with a single repeat unit of the following structure:

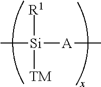

The term “preceramic composition” as used herein refers to the elemental composition of preceramic. In some embodiments, said composition comprises a preceramic short chain polymer with 1-100 of the following repeat unit:

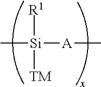

The composition may be in the form of a coating.

The term “preceramic short chain polymer” as used herein refers to short-chain molecular preceramic precursors for use in preparing ceramics, such as ultrahigh temperature ceramics, for thermal protection systems, and passivation coating, with 1-100 repeat units of the following:

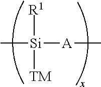

One aspect of the invention pertains to

In further embodiments, the term “preceramic short chain polymer” refers to a polymer of Formula I

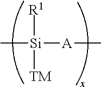

wherein
A is CH₂, NR₂, CR₂, where R is H, alkyl.
R¹ is independently hydrogen, alkyl (e.g., methyl, ethyl, propyl), or ethyl;
TM is a Group IV, V, or V transition metal (e.g., titanium, vanadium, chromium, zirconium, niobium, molybdenum, hafnium, tantalum, and tungsten); and
x is 1-100, 1-30, 30-60, 60-80, or 80-100.

A further aspect of the invention pertains to a preceramic composition comprising a preceramic monomer of Formula I. Another aspect of the invention pertains to a preceramic composition comprising a preceramic polymer comprising a monomer of Formula I:

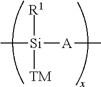

wherein
A is CH₂, NR₂, CR₂, where R is H, alkyl.
R¹ is independently hydrogen, alkyl, or ethyl;
TM is a Group IV, V, or V transition metal; and
x is 1-100.

The composition further comprises a filler.

The filler is an inorganic ceramic or metal particle solid chosen from carbides, borides, nitrides, niobium particles, copper particles, hafnium diboride (HfB₂), tantalum carbide (TaC), niobium carbide (NbC), or titanium diboride (TiB₂).

In further embodiments the composition is in the form of a coating. The term “coating” as used herein refers to the preceramic precursor derived ultrahigh temperature ceramic coating materials deposited onto the structural component.

Another aspect of the invention pertains to A method of making a preceramic short chain polymer of Formula I, said method comprising crosslinking a monomer of Formula I′ in the presence of Group IV, V, or V transition metal and heat to obtain a monomer of Formula I;

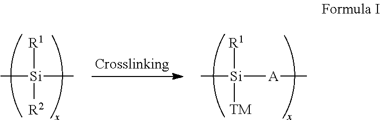

wherein
A is CH₂, NR₂, CR₂, where R is H;
R¹ is independently hydrogen, alkyl (e.g., methyl, ethyl, propyl), or ethyl;
R² is independently hydrogen, alkyl (e.g., methyl, ethyl, propyl), or ethyl;
TM is a Group IV, V, or V transition metal (e.g., titanium, vanadium, chromium, zirconium, niobium, molybdenum, hafnium, tantalum, and tungsten); and
where x is 1-100.

### LIST OF EMBODIMENTS

The following is a non-limiting list of embodiments:
1. A preceramic short chain polymer of Formula I:

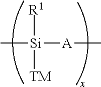

wherein
A is CH₂, NR₂, CR₂, where R is H, alkyl.
R¹ is independently hydrogen, alkyl (e.g., methyl, ethyl, propyl), or ethyl;
TM is a Group IV, V, or V transition metal; and
x is 1-100.
2. The preceramic short chain polymer of embodiment 1, wherein said transition metal is titanium, vanadium, chromium, zirconium, niobium, molybdenum, hafnium, tantalum, and tungsten.
3. The preceramic short chain polymer of embodiment 1, wherein said transition metal is in the form of a transitional metal salt.
4. The preceramic short chain polymer of embodiment 3, wherein said transition metal salt is zirconium (IV) halide (e.g., zirconium (IV) chloride), molybdenum (III) oxide, tungstosilicic acid hydrate, hafnium (IV) halide (e.g., hafnium (IV) chloride), or vanadium (III) halide (e.g., vanadium (III) chloride).
5. A preceramic short chain polymer comprising a monomer of Formula I:

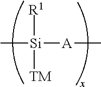

wherein
A is CH₂, NR₂, CR₂, where R is H, alkyl.
R¹ is independently hydrogen, alkyl (e.g., methyl, ethyl, propyl), or ethyl;
TM is a Group IV, V, or V transition metal; and
x is 1-100.
6. The preceramic short chain polymer of embodiment 3, wherein said transition metal is titanium, vanadium, chromium, zirconium, niobium, molybdenum, hafnium, tantalum, and tungsten.
7. The preceramic short chain polymer of embodiment 5, wherein said transition metal is in the form of a transitional metal salt.
8. The preceramic short chain polymer of embodiment 7, wherein said transition metal salt is zirconium (IV) halide (e.g., zirconium (IV) chloride), molybdenum (III) oxide, tungstosilicic acid hydrate, hafnium (IV) halide (e.g., hafnium (IV) chloride), or vanadium (III) halide (e.g., vanadium (III) chloride).
9. A preceramic composition comprising a preceramic monomer of Formula I.
10. A preceramic composition comprising a preceramic polymer of embodiment 5.
11. The composition according to embodiments 9 or 10, wherein said composition further comprises a filler.
12. The composition of embodiment 11, wherein said filler is an inorganic particle.
13. The composition of embodiment 11, wherein said filler is a ceramic or metal particle solid.
14. The composition of embodiment 13, wherein said ceramic or metal particle solid is chosen from carbides, borides, nitrides, niobium particles, or copper particles.
15. The composition of any of the preceding embodiments, wherein said filler is hafnium diboride (HfB₂), tantalum carbide (TaC), niobium carbide (NbC), or titanium diboride (TiB₂).
16. The composition according to embodiments 9 or 10, wherein said composition is in the form of a coating.
17. A method of making a preceramic short chain polymer of Formula I, said method comprising crosslinking a monomer of Formula I′ in the presence of Group IV, V, or V transition metal and heat to obtain a monomer of Formula I;

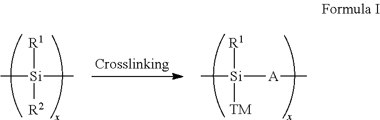

wherein,
A is CH₂, NR₂, CR₂, where R is H;
R¹ is independently hydrogen, alkyl (e.g., methyl, ethyl, propyl), or ethyl;
R² is independently hydrogen, alkyl (e.g., methyl, ethyl, propyl), or ethyl;
TM is a Group IV, V, or V transition metal; and
where x is 1-100.
18. The method of embodiment 17, wherein said transition metal is titanium, vanadium, chromium, zirconium, niobium, molybdenum, hafnium, tantalum, and tungsten.
19. The method of embodiment 17, wherein said transition metal is in the form of a transitional metal salt.
20. The method of any of embodiment 19, wherein said transition metal salt is zirconium (IV) halide (e.g., zirconium (IV) chloride), molybdenum (III) oxide, tungstosilicic acid hydrate, hafnium (IV) halide (e.g., hafnium (IV) chloride), or vanadium (III) halide (e.g., vanadium (III) chloride).

### Example 1. Introduction

There is a growing demand of advanced materials with intricate geometries that can withstand extreme environments. Compositionally complex ceramics stand out due to their high-temperature stability, highly distorted lattices, and a unique combination of metallic, covalent, and ionic bonding.^{3,4} The traditional ceramic powder approach offers limited compositional flexibility and often leads to heterogeneity due to broad particle size distribution and insufficient interfacial connections between particles. The ceramics obtained from chemically distinct preceramic polymer precursors (PCPs) usually feature a combination of shaping and manufacturing with the chemical composition and microstructural control not achievable by other methods. In addition, the PCPs have gained significant attention due to their ability to tailor the polymer composition at molecular scale, with the ability to further develop complex compositions and thus form metastable compositions following pyrolysis. However, the distinctive drawbacks of the PCPs are the shrinkage and structural integrity of nano-domain transformation by pyrolysis, uncontrolled porosity from significant gas release (a drastic density change), and pyrolysis-sensitive stoichiometry of multi-elemental atoms in compositionally complex ceramics. These have a substantial impact on the thermo-mechanical characteristics of the formed structure, as they tend to lack adequate oxidation resistance at high temperatures. Furthermore, these Si-based PCPs conventionally use long-chain polymers, making it challenging to incorporate different elements uniformly on individual monomers or crosslink different species, as transition elements tend to distribute non-uniformly along the polymeric chains. Furthermore, the decomposition temperature of these polymers is directly proportional to the polymeric chain length. Moreover, the PCPs use higher pyrolysis temperatures with the need for protective environments (>1000° C.) which causes issues with high throughput and scalability. This calls for new preceramic chemistry, particularly at the nanometric level, with new pyrolysis processes to attain a preceramic green body into a dense ceramic.

Herein, a preceramic molecular approach based on the crosslinking of transition metal salts with short-chain preceramic molecular monomers, together with the electrical pyrolysis to additively manufacture compositionally complex ceramics with high-temperature stability is demonstrated. The use of monomers rather than long chain polymers enables greater control of the transition metal dispersion on an atomic level, which also promotes the interaction of filler particles for the formation of dense, pore-free ceramics. The transition metal elements from the groups 4-6 were crosslinked to preceramic monomers, resulting in compositionally complex ceramics, which can be electrically pyrolyzed at lower temperatures within a short time span. As proof of concept, zirconium (IV) chloride (ZrCl₄) was crosslinked to polydimethylsilane (PDM) along with zirconium diboride (ZrB₂). Following pyrolysis at just 1073 K for 1 minute in air, Zr—Si—O—C—B ceramics that are dense and nearly pore-free, with multiple homogenously dispersed phases in the final structure that promote greater high-temperature stability was achieved. Furthermore, additional transition metals including hafnium (Hf), vanadium (V), chromium (Cr), molybdenum (Mo) and tungsten (W) were explored as crosslinking elements, alongside with additional filler including hafnium diboride (HfB₂), tantalum Carbide (TaC), niobium carbide (NbC) and titanium diboride (TiB₂), thus demonstrating the universality of this approach. These ceramics can be additively manufactured onto various metals and conformal structures to enable thermal management of the metal base via suppressing oxidation at elevated temperatures (as a demonstration, a resistivity change from 1.36×10⁻⁵ Ω·cm at 293 K to 2.61×10⁻⁵ Ω·cm at 1422 K was observed for copper metal base coated with thin ceramic film). The ceramic film exhibits excellent stability when exposed to temperatures of 1873 K in the air. Besides thin film coatings, the feedstock can also be used to fabricate bulk ceramic pellets. Furthermore, the speed and scalability of the ceramic formation enables rapid screening of different compositions as oxidative barrier coatings on metals or other intricate structures. This could enable rapid discovery of novel protective ceramics that can be utilized for a broad range of applications taking place under extreme conditions.

### Example 2. Results and Discussion

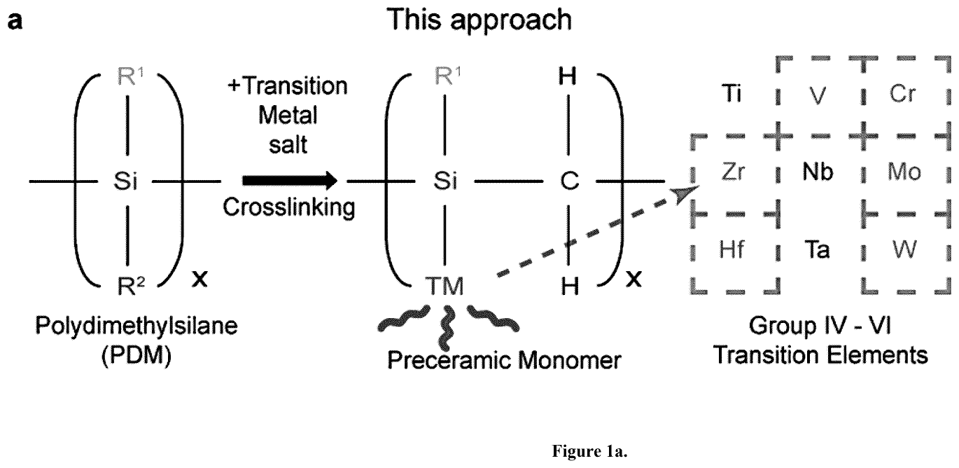

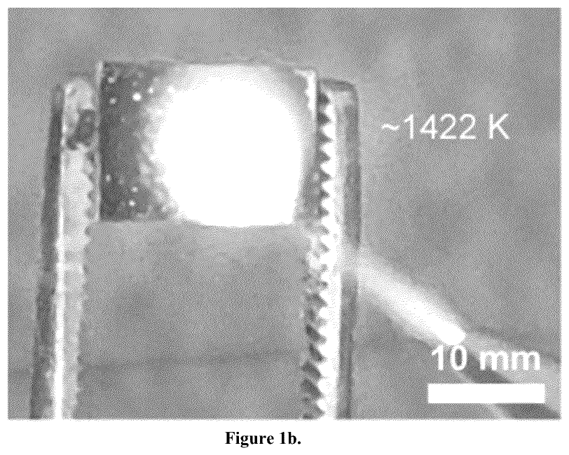

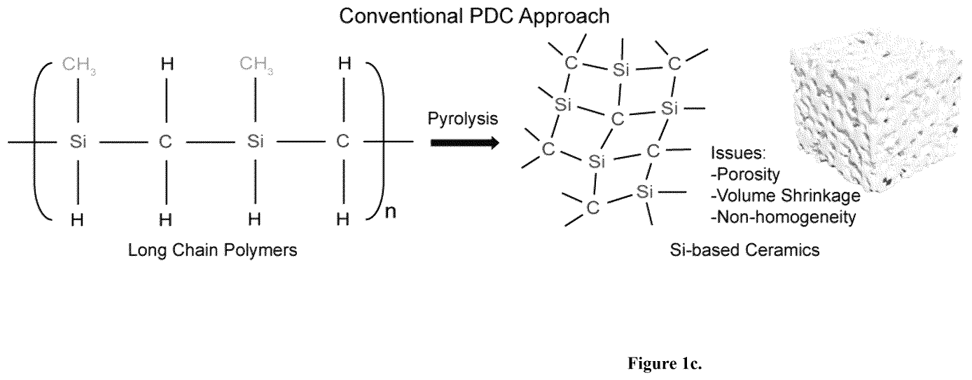

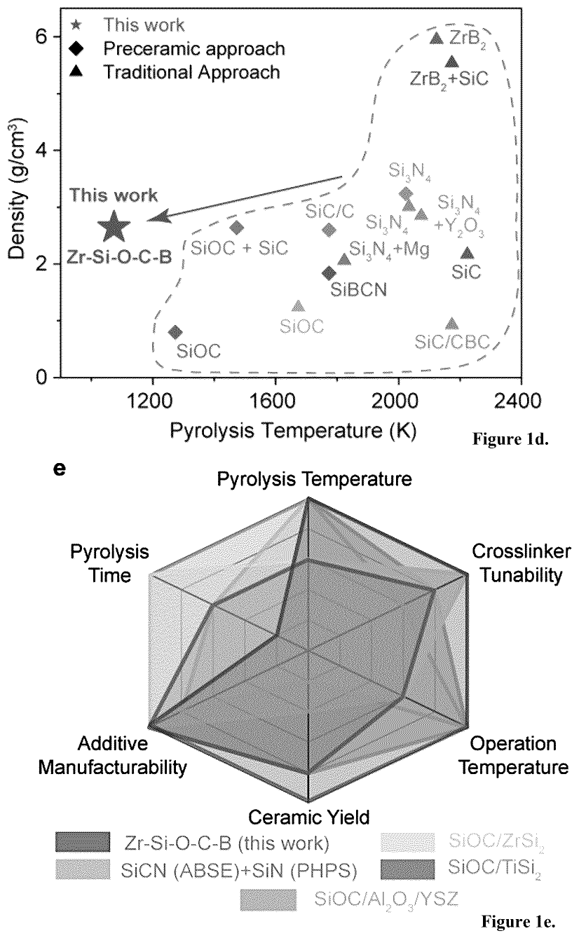

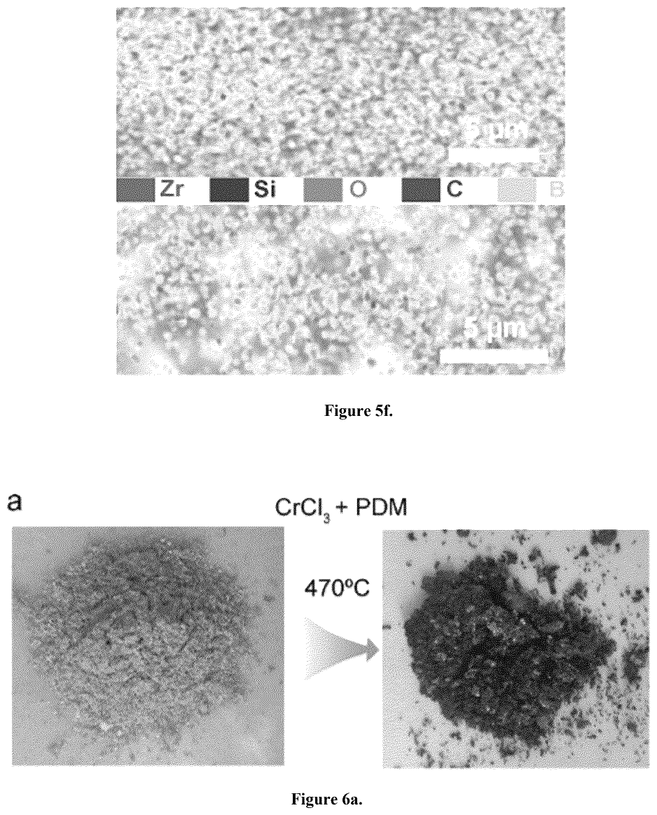

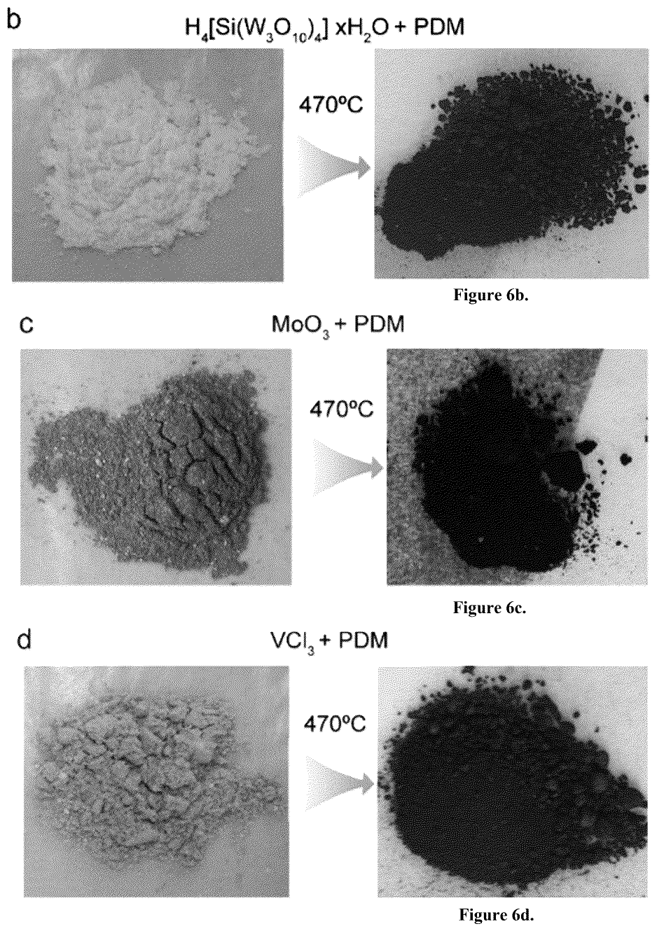

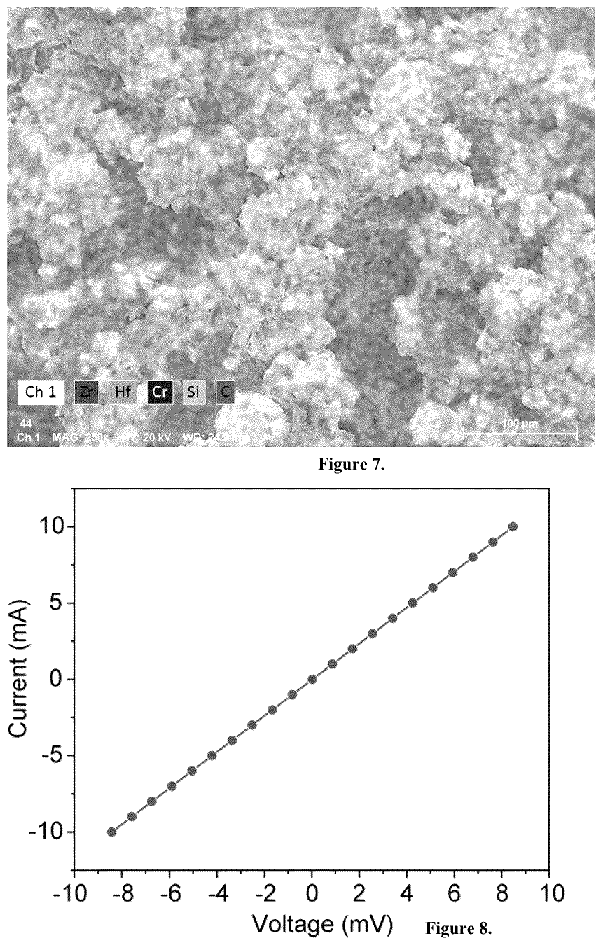

FIG. 1a illustrates the scheme for the synthesis of multi-element, compositionally complex preceramic precursor, and illustrates the precursor synthesis process, with the starting materials of PDM and metallic salts (zirconium (IV) chloride, molybdenum (III) oxide, tungstosilicic acid hydrate, hafnium (IV) chloride, or vanadium (III) chloride). The PDM converts to polycarbosilane (PCS, a polymeric precursor for silicon carbide) through a reflux reaction, and thermally crosslinks with metallic salts to form a single source preceramic monomer, designated as M-PCS. For this study, ZrCl₄ salt was selected, thus designating M as Zr in M-PCS precursor source, which after thermal curing exhibits yellow color. Additional individual transition element salts such as Chromium (Cr), Hafnium (Hf), Molybdenum (Mo) and Vanadium (V) that have been crosslinked with PCS for increasing the design space for preceramic monomers, can be found in FIG. 6. For a multi-transition element precursor, Zr, Hf and Cr was crosslinked with PCS via thermal curing, and was characterized through EDS mapping to determine and visualize the element distribution, as seen in FIG. 7. The preceramic precursor slurry consists of the transition metal crosslinked preceramic polymer and ZrB₂ filler particles. FIG. 1b shows the electrified pyrolysis of ceramics for applications relating to harsh conditions under the influence of oxygen-hydrogen torch, with temperatures reaching upwards of 1422 K, with the supporting video Supplementary Movie M1 depicting this phenomenon. For comparison, FIG. 1c depicts the conventional approach employed towards the synthesis of polymer-derived ceramics, mostly limited to silicon-based polymers, typically consisting of long polymeric chains, which upon pyrolysis at elevated temperatures and protective environments, results in the conversion to corresponding silicon-based ceramics. FIG. 1d shows an Ashby plot comparing the different methods for manufacturing ceramics with requisite pyrolysis temperature and the density of the resulting ceramic. From the plot, the ceramics obtained in this work have the lowest pyrolysis temperature with a density comparable to that of Si-based preceramic and traditional ceramic manufacturing techniques. FIG. 1e shows a radar chart comparing performance parameters like pyrolysis temperature, pyrolysis time, additive manufacturability, crosslinker tunability, ceramic yield and operation temperature for thermal management of the PCP materials reported in literature and this work. Briefly, the ceramics presented in this work offer high ceramic yield, additive manufacturability, crosslinker tunability and ultrafast pyrolysis, and oxidation-resistance at high operating temperature.

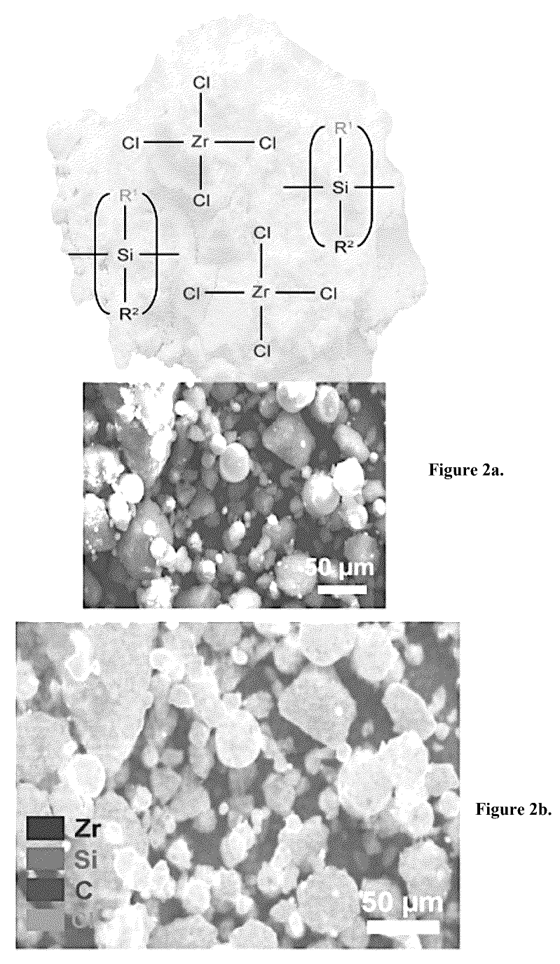

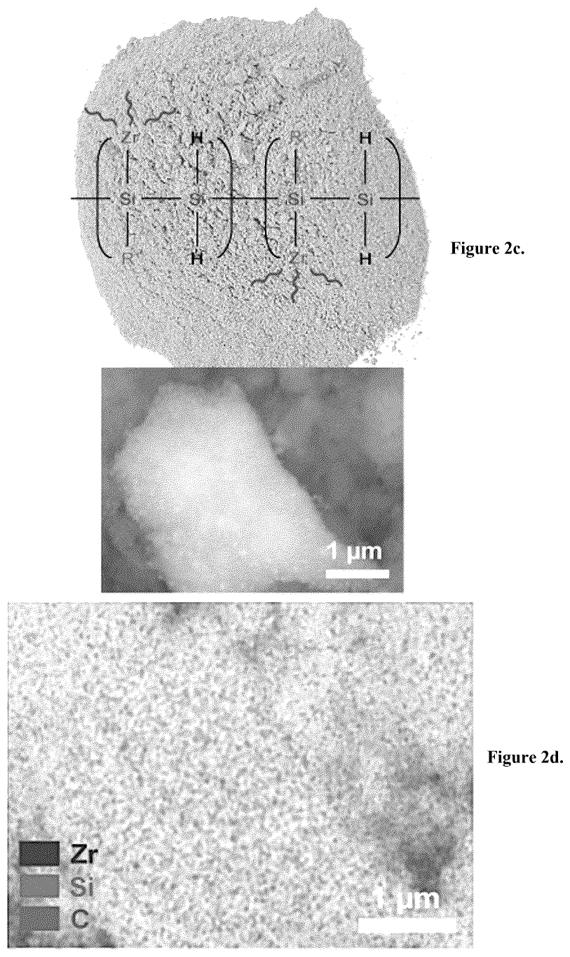

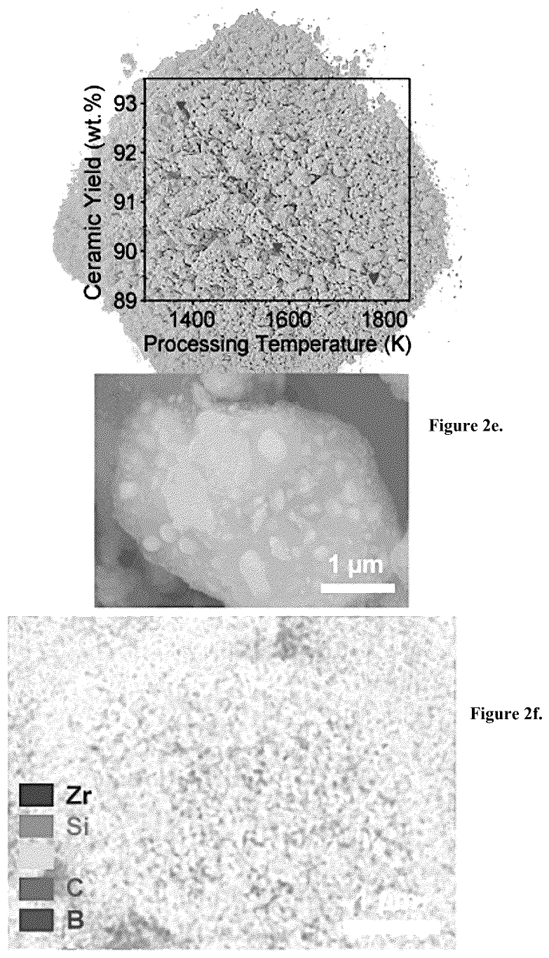

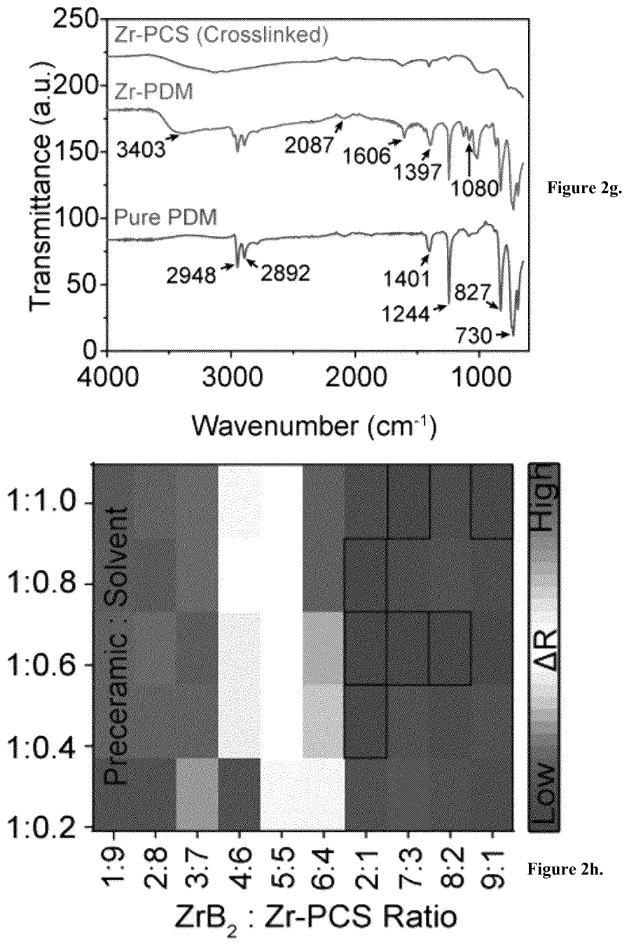

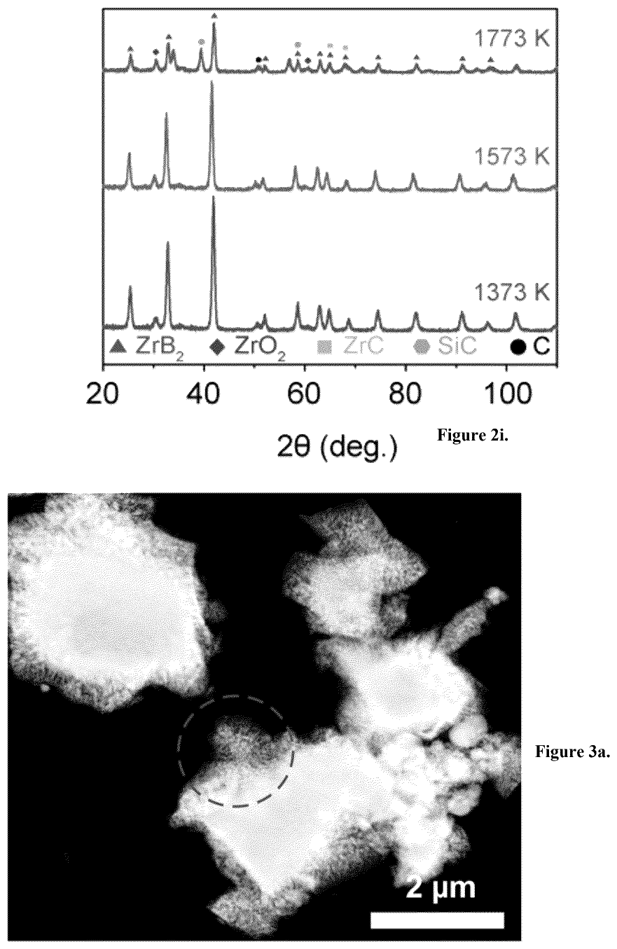

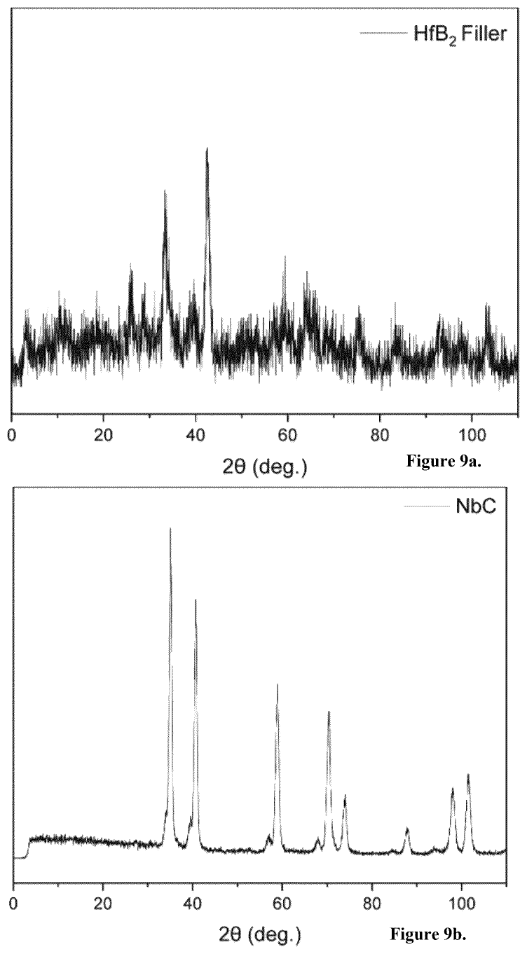

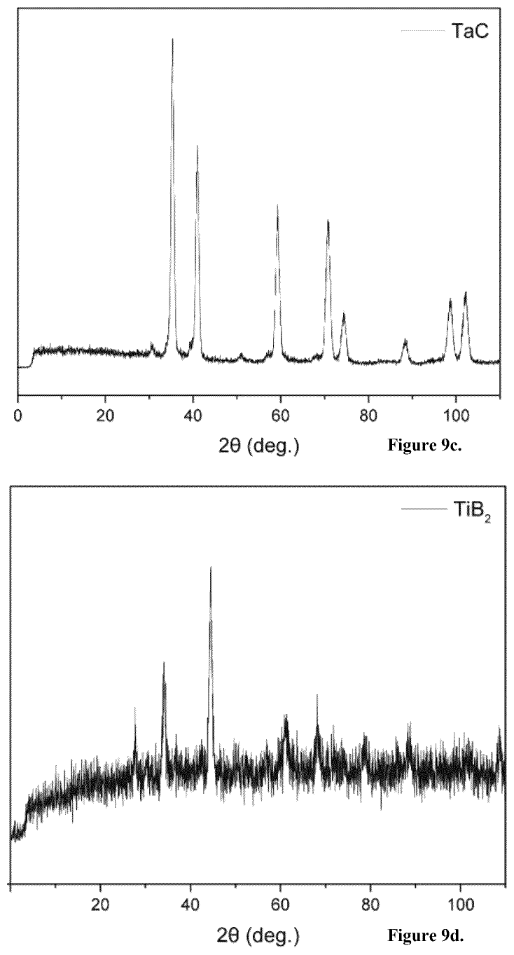

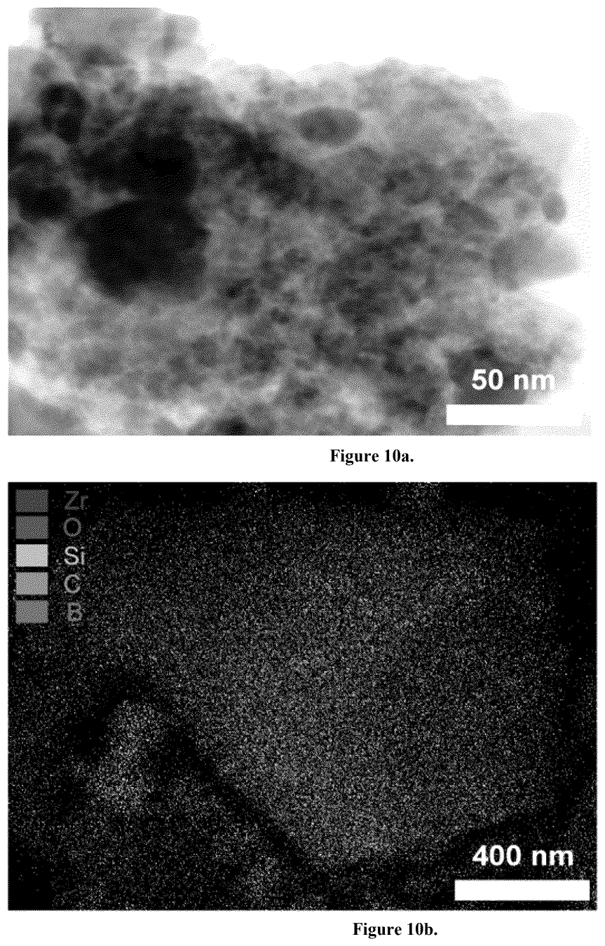

The pre-ceramic polymers typically have a low molecular weight, resulting in a relatively low ceramic yield when subjected to pyrolysis. To prevent the evaporation of oligomers during pyrolysis, cross-linking of the precursor into macro-molecules with tightly interlocked backbones is beneficial. FIG. 2a depicts the starting precursor material with the added ZrCl₄, a transition element source. The inset in FIG. 2a shows the scanning electron microscopy (SEM) image of Zr-PDM precursor prior to crosslinking with energy dispersive spectroscopy (EDS) elemental mapping indicative of segregated ZrCl₄ and PDM particles shown in FIG. 2b. Following crosslinking reaction, the ZrCl₄-PDM (designated as Zr-PDM from here on) transforms to Zr—PCS, as seen in FIG. 2c. The inset in FIG. 2c shows the SEM image of Zr—PCS following cross-linking reaction with EDS mapping (FIG. 2d) indicative of uniform elemental distribution throughout, corroborating the cross-linking reaction that has occurred. This characterization was conducted to ensure homogenous distribution of elements. When selecting fillers for the preceramic polymer, it is preferable to prioritize ceramic yield that exceeds 75%, as it is preferable to minimize weight loss and shrinkage of the polymer during pyrolysis, as PCPs with fillers result in a high ceramic yield and densification. To this extent, Zr—PCS preceramic polymer was hybridized with ZrB₂ filler particles for improving the ceramic yield and further enhance its high temperature stability. The XRD characterization was done for precursors with different transition elements besides Zr (Cr, Hf, Mo, V and W, designated as ‘M’ in M-PCS) with ZrB₂ filler particles following pyrolysis. This was done to facilitate the compatibility of this process with different elements. The addition of ZrB₂ filler also facilitates electrified joule heating due to its conductive nature, ranging from 6-23 μΩ·cm at room temperature, as seen in FIG. 8. FIG. 2e shows the optical image of the Zr—Si—O—C—B powder, obtained via the pyrolysis of Zr—PCS powder mixed with ZrB₂. Preceramic precursors with Hf as the transition element crosslinked with PCS and mixed with ZrB₂ filler particles was also synthesized, and characterized via SEM and EDS mapping, enabling the identification of individual elements (Hf, Zr, Si, O, C and B). The inset in FIG. 2e (bottom) shows the SEM image of the following pyrolysis after addition of filler particles. Besides ZrB₂, other fillers including hafnium diboride (HfB₂), tantalum carbide (TaC), niobium carbide (NbC) and titanium diboride (TiB₂) were also examined for their compatibility with the processing method illustrated in this study. Furthermore, XRD characterization of preceramic precursors consisting of base Zr—PCS with different filler particles (HfB₂, NbC, TaC and TiB₂) was also conducted for validating universal compatibility with filler particles and identification of the phases following pyrolysis, as seen in FIG. 9. FIG. 2f shows the EDS elemental mapping of a uniform cluster of Zr—Si—O—C—B particles. This is further supported via the transmission electron microscope (TEM) image with EDS mapping overlay for Zr—Si—O—C—B particles as described in FIG. 10. The inset in FIG. 2f (top) shows the yield of the precursor powder pyrolyzed at different temperatures. The addition of ZrB₂ particles reduces the weight loss to ˜7-10 wt. %, which is significantly lower when compared directly to that observed during thermal curing of Zr—PCS.

To further validate the crosslinking reaction, the Fourier transform infrared spectroscopy (FTIR) for the precursor source is shown in FIG. 2g. It consists of pure PDM, Zr-PDM prior to crosslinking, which converts to Zr—PCS following crosslinking reaction. The wavenumbers of the absorption peaks are at 3403 cm⁻¹ corresponding to C═C, 2948 cm⁻¹ and 2982 cm⁻¹ corresponding to CH₃ stretching, 1606 cm⁻¹ corresponding to C═C stretching in CH═CH₂, 1397 cm⁻¹ corresponding to CH₂ deformation in Si—CH₂—Si, 2087 cm⁻¹ and 1244 cm⁻¹ corresponding to Si—H and Si—CH₃ deformation respectively, and were introduced by poly(dimethylsilane), 1080 cm⁻¹ corresponding to CH₂ bending in Si—CH₂—Si, 827 cm⁻¹ corresponding to Si—C stretch and 730 cm⁻¹ corresponding to Si—C stretching in Si—CH₃. It should be noted that dehydrochlorination (M-Cl/Si—H) leads to incorporation of Zr into polycarbosilane chains. The Zr cations are crosslinked with the PCS chain via the mechanism of dehydrochlorination (Zr—Cl/Si—H), which leads to the consumption of Si—H groups. Additionally, as a consequence of hydrosilylation (C—C/Si—H), C—C groups are consumed, as indicated by the almost disappearing absorption peak at 1606 cm⁻¹ in Zr—PCS. This corroborates that introducing Zr functions as a catalyst for the hydrosilylation. Moreover, compared to Zr-PDM powder, there is significant reduction in adsorption peaks, specifically at 3403 cm⁻¹, further indicating the crosslinking of Zr—PCS. The FTIR spectra of different transition metals following the crosslinking reaction with PCS is depicted in FIG. 11, which was conducted to confirm the occurrence of the cross-linking reaction.

Due to the growing chemical complexity for the search of preceramic derived ceramics, the number of possible combinations is too vast for an Edisonian method to be feasible. A screening method for determination of precursor feedstock could significantly suppresses the processing times with the accelerated material development. Leveraging the ratios between Zr—PCS, ZrB₂ filler particles and the solvent, the resistance change (4R) of ceramic coated copper layer between room temperature and 1273 K as the criterion was utilized for screening in this study. For screening purposes, ten different weight ratios of ZrB₂ and Zr—PCS powders (1:9, 2:8, 3:7, 4:6, 5:5, 6:4, 7:3, 8:2, 9:1 and 2:1) were identified, with five weight ratios of solvents (0.2, 0.4, 0.6, 0.8 and 1 wt. %) in combination with each ZrB₂: Zr—PCS ratio. From FIG. 2h, it is evident that higher weight ratio of ZrB₂ filler particles is beneficial for high temperature stability, coupled with higher solvent ratio, which aids in rapid prototyping of samples coupled with electrical pyrolysis. From the heat map, ZrB₂: Zr—PCS ratios of 2:1 with solvent ratios of 0.4 (ΔR=0.44), 0.6 (ΔR=0.33), and 0.8 wt. % (ΔR=0.42), 7:3 with solvent ratios of 0.6 (ΔR=0.28) and 1 wt. % (ΔR=0.38), 8:2 with solvent ratios of 0.6 (ΔR=0.31) and 9:1 with solvent ratios of 1 wt. % (ΔR=0.47) had the lowest ΔR, the values for which have been enlisted in Table 1.

TABLE 1
Screening study results for varying powder and solvent ratios

| ZrB₂:Zr- | ΔR for | ΔR for | ΔR for | ΔR for | ΔR for |
|---|---|---|---|---|---|
| PCS Ratio | 1:0.2 | 1:0.4 | 1:0.6 | 1:0.8 | 1:1 |
| 1:9 | — | 19000 | 27564 | 37900 | 61370 |
| 2:8 | — | 21380 | 18390 | 52765 | 27308 |
| 3:7 | 3540 | 27009 | 33670 | 13653 | 17550 |
| 4:6 | — | 308.76 | 407.5 | 191 | 211 |
| 5:5 | 281.4 | 191.07 | 188.6 | 120.8 | 106.37 |
| 6:4 | 72.9 | 19.31 | 16.4 | 3.09 | 2.293 |
| 2:1 | 0.9802 | 0.4449 | 0.3344 | 0.427 | 0.666 |
| 7:3 | 1.55 | 1.03 | 0.285 | 0.83 | 0.3846 |
| 8:2 | 1.1 | 0.65 | 0.316 | 1.082 | 0.634 |
| 9:1 | 0.9 | 0.987 | 0.53 | 0.88 | 0.4736 |

ZrB₂: Zr—PCS ratio of 2:1 with a solvent ratio of 0.6 wt. % was selected for the purpose of this study. FIG. 2i shows the x-ray diffraction analysis patterns for the powders pyrolyzed at different temperatures. From the plot, multiple phases can be identified; namely, ZrB₂, ZrO₂, ZrC, and SiC and C. The presence of ZrB₂, ZrC and ZrO₂ can be attributed to the reaction of Zr with PCS and the solvent. Additionally, PCS primarily forms silicon carbide, graphite and/or carbon at elevated temperatures.

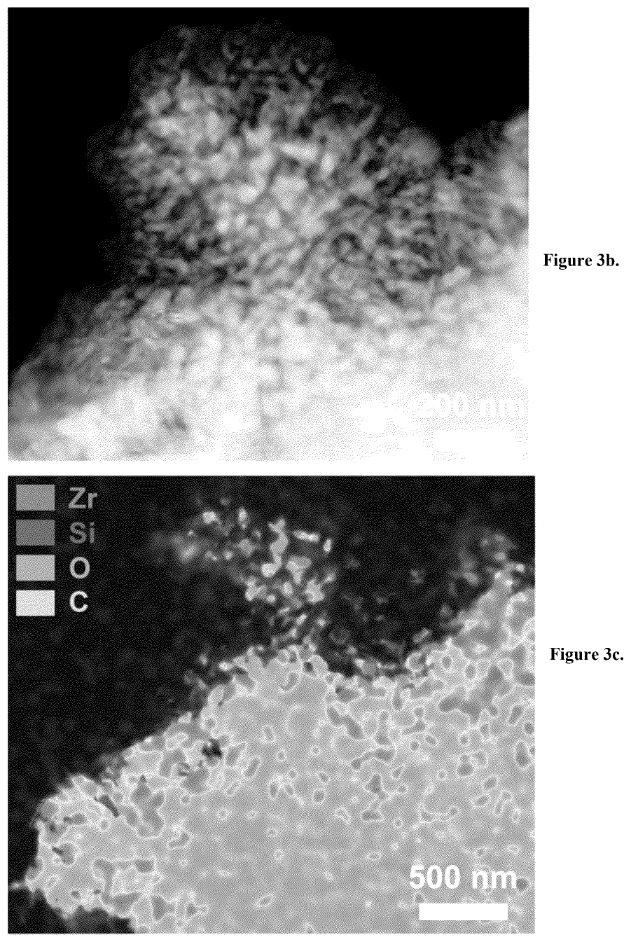

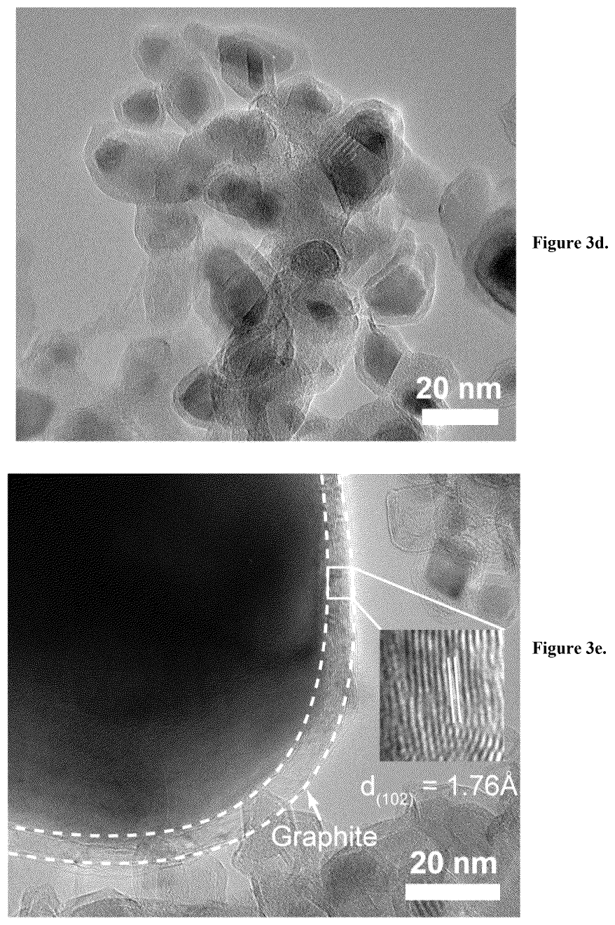

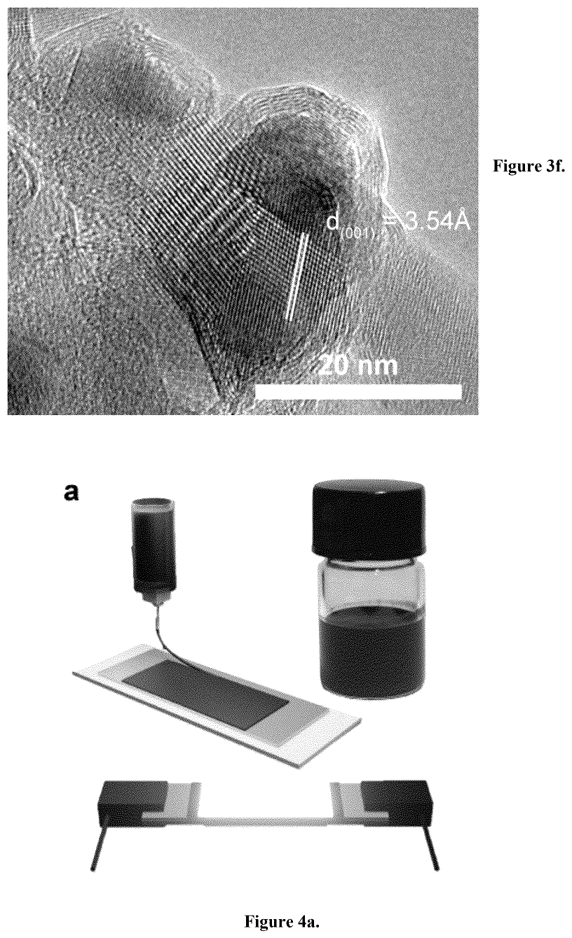

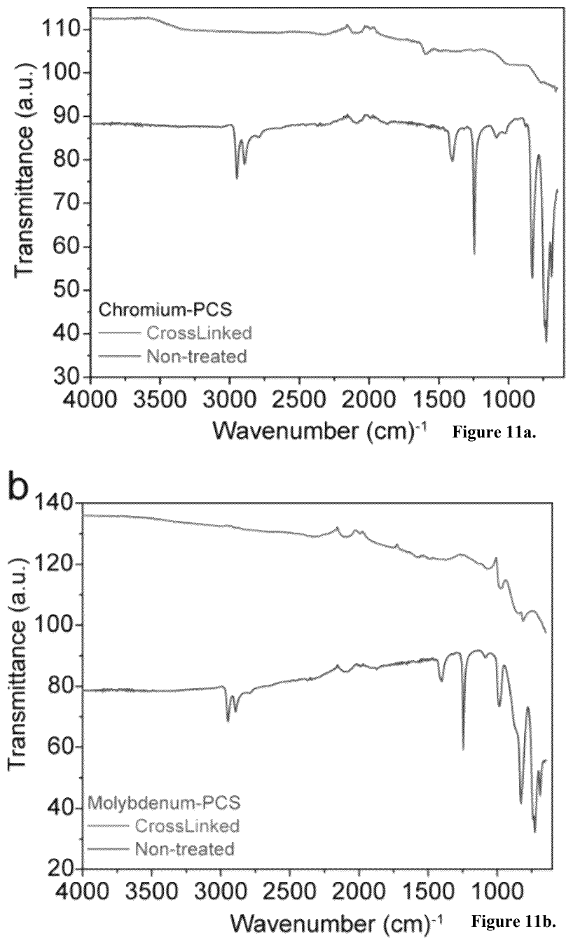

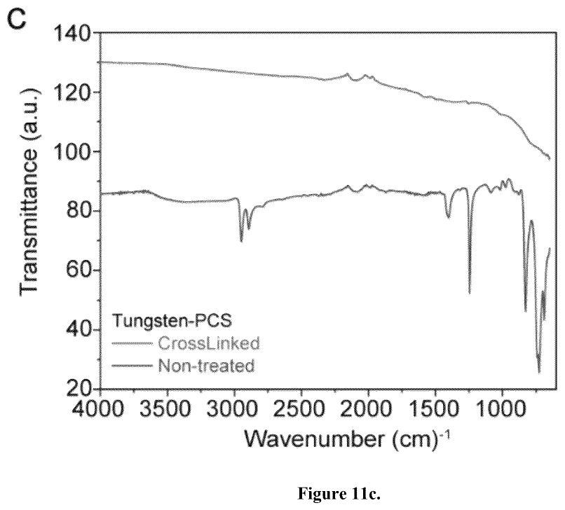

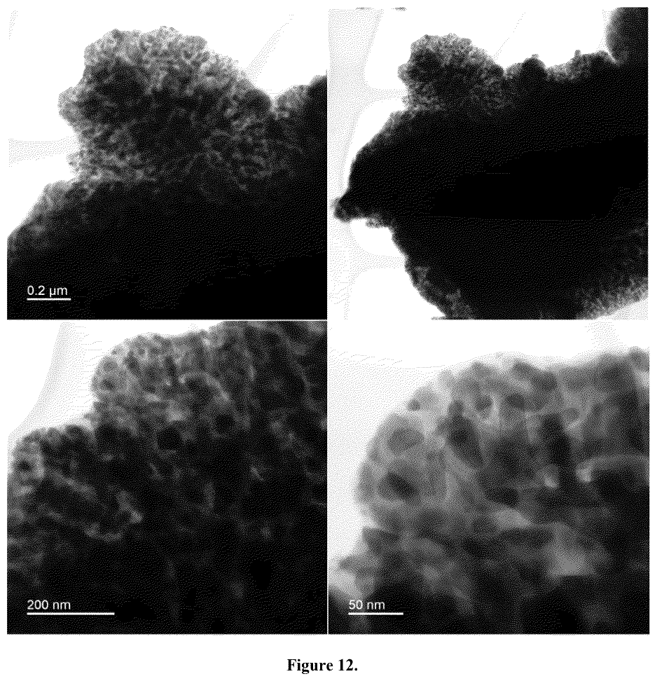

To elucidate the microstructure of the Zr—Si—O—C—B ceramics, transmission electron microscopy (TEM) and scanning transmission electron microscopy (STEM) were employed. Low-magnification TEM images (FIG. 3a, FIG. 12) reveal micron-sized clusters formed after pyrolysis of the preceramic precursor with ZrB₂ fillers, comprising particles ranging from 20 to 100 nm (FIG. 3b). The TEM-EDS mapping (FIG. 3c) provides a detailed spatial distribution of Zr, Si, O, and C elements, highlighting the incorporation of Zr within the matrix while the presence of Si, O, and C at the shell layer. Additional EDS maps further corroborate these findings across different regions of the sample. High-resolution TEM (HRTEM) imaging (FIG. 3d) distinguishes the crystalline ZrB₂ phase from the surrounding matrix. The HRTEM analysis reveals that the ZrB₂ nanoparticles are encapsulated within a graphitic carbon layer, forming a core-shell structure. The presence of graphene-like domains is supported by the observation of lattice fringes at d (102)=1.76 Å (FIG. 3e), indicative of ordered carbon structures. Meanwhile, lattice fringes at d (002)=3.54 Å (FIG. 3f) correspond to the (002) planes of ZrB₂, confirming the retention of crystalline integrity in the ZrB₂ cores following pyrolysis. This structural heterogeneity contributes to the material's thermal stability and oxidation resistance, with the graphitic carbon shell providing a barrier against thermal degradation. At elevated temperatures (up to 1673 K), further decomposition of the surrounding phases leads to the formation of turbostratic carbon—a less ordered variant of graphite—and SiC phases, while preserving the crystallinity of ZrB₂. The resulting hybrid microstructure, which integrates graphene-like carbon with ZrB₂ cores, enhances the material's thermal conductivity and mechanical robustness, maintaining structural integrity under extreme conditions. The simultaneous presence highlights the intricate interaction between carbon and ceramic phases, resulting in a composite with superior stability and functionality at elevated temperatures.

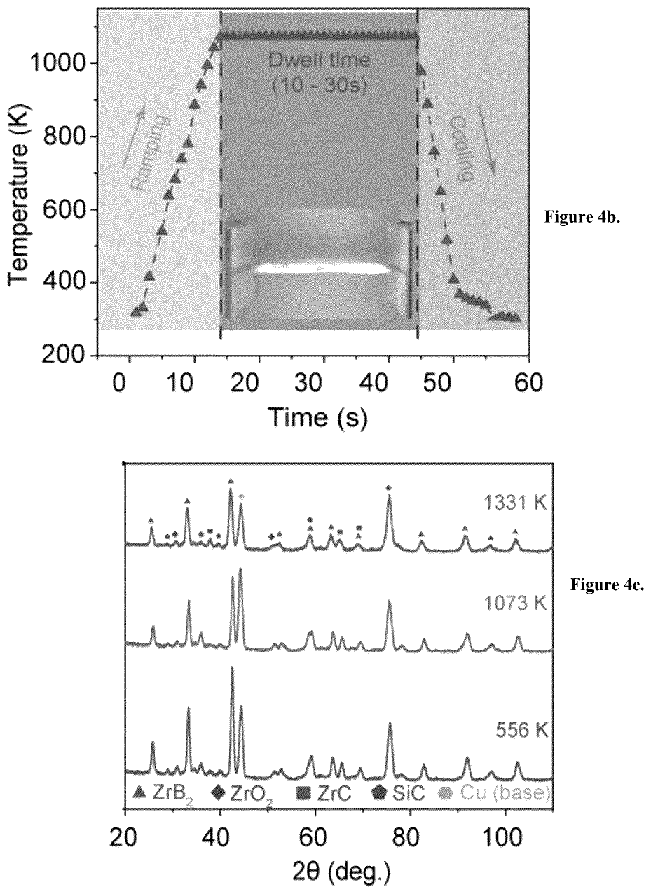

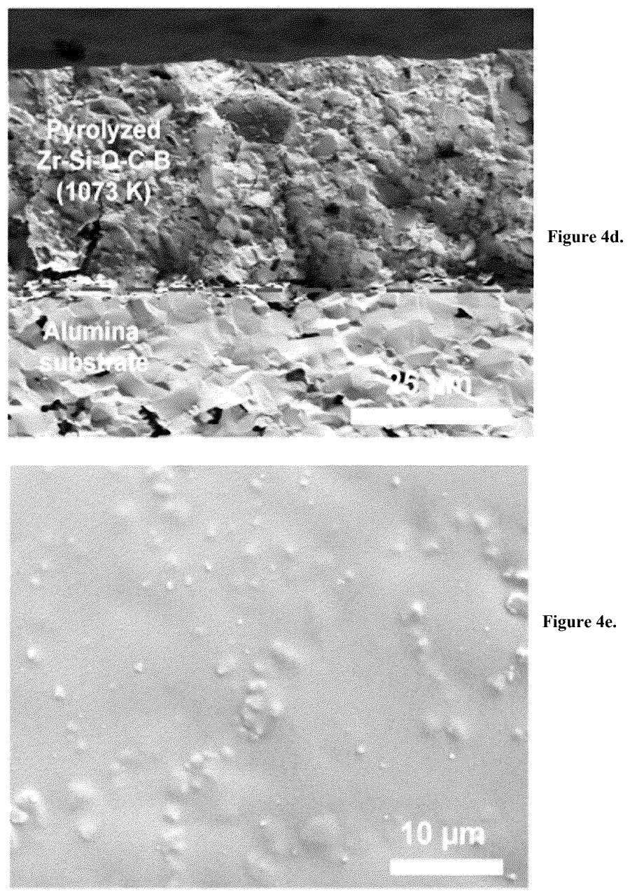

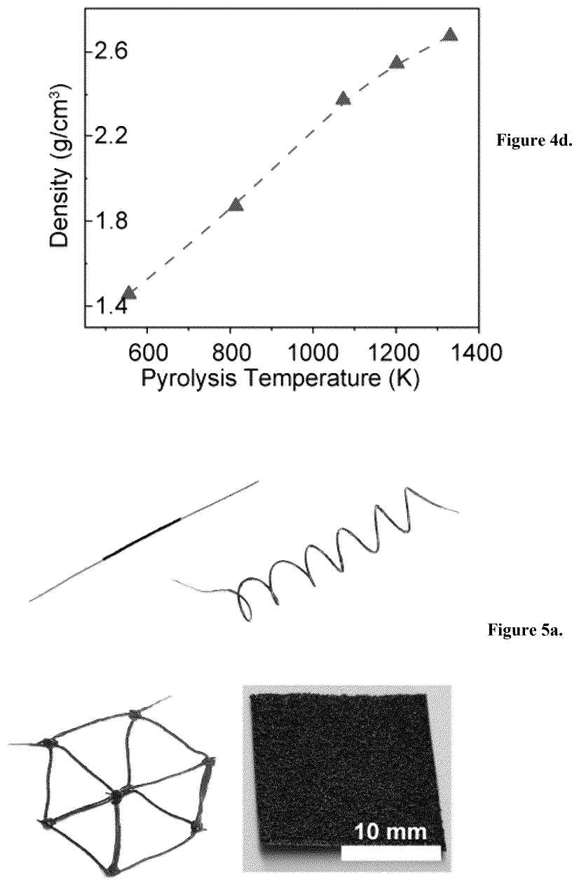

As the dispersible nature of preceramic materials allows for tuning of the rheological properties, the liquid preceramic precursor can be additively manufactured using direct writing. FIG. 4a depicts the additive manufacturing process following synthesis of the printable slurry for creating dense ceramic films. A modified electrical current assisted sintering is further employed for rapid pyrolysis of the preceramic slurry via applying a DC electric field within a short time span, as opposed to hours at elevated temperatures in conventional processing methods. This effect can be explained via Joule heating at the local grain boundaries, enhancing diffusion of the grain boundaries (kinetic effect) while inhibiting grain growth (thermodynamic effect). With the synergistic combination of higher temperatures at the grain boundaries and smaller grain sizes, the sintering rate is significantly improved, as can be observed in Supplementary Movie M2. FIG. 4b shows the temperature-time profile of the electrical pyrolysis process for a power of 40 W, with a dwelling time of ˜ 10-30 seconds at the set temperature to allow densification, the entire pyrolysis process is completed under 60 seconds, with printed copper as the conductive substrate layer. The inset in FIG. 4b shows the optical image of the electrical pyrolysis process and can be visualized in the Supplementary Movie M3. The XRD diffractograms were collected for samples electrically pyrolyzed at different input powers, as depicted in FIG. 4c. From the plot, four distinct phases were revealed, ZrB₂, ZrO₂, ZrC and SiC. These phases are a consequence of a mixture of two different phases resulting in a third phase. The synergistic effect of all these phases enhanced stability and reliability to the ceramic coatings at elevated temperatures. Furthermore, XRD diffractograms for additional preceramic slurries consisting of different transition elements (Cr, Hf, Mo, V and W) following electrical pyrolysis were also collected and reported. Similarly, XRD diffractograms for preceramic slurries consisting of Zr—PCS mixed with different fillers following electrical pyrolysis was observed, further corroborating the universal approach of electrical pyrolysis. FIG. 4d shows the cross-sectional SEM observation of the electrically pyrolyzed ceramics. From the SEM, it can be inferred that the sample is dense, with no visible cracks or pores. Additional SEM images with varying magnifications depicting the cross-sectional view of Zr—Si—O—C—B sample following electrical pyrolysis are presented in FIG. 13, supported by the EDS mapping, visualizing the element distribution of the compositionally complex Zr—Si—O—C—B ceramic. FIG. 4e shows the SEM observation of a sample electrically pyrolyzed at a temperature of 1073 K. Additional plane view SEM images for preceramic slurries consisting of different transition elements (Cr, Hf, Mo, V and W) following electrical pyrolysis were also collected. From the SEM observations, as the pyrolysis temperature goes on increasing from 556 K, the surface uniformity increases. However, after 1073 K, no significant change is observed in the quality of the surface. The EDS mapping for this sample was performed to corroborate the presence and uniform distribution of Zr, Si, O, C and B elements following electrical pyrolysis at 30 W. Furthermore, adhesion was performed on the electrically pyrolyzed Zr—Si—O—C—B sample. FIG. 4f depicts the density plot for samples electrically pyrolyzed at various temperatures. As increasing the pyrolysis temperature, the density of the ceramic films goes on increasing due to closer packing of the particles.

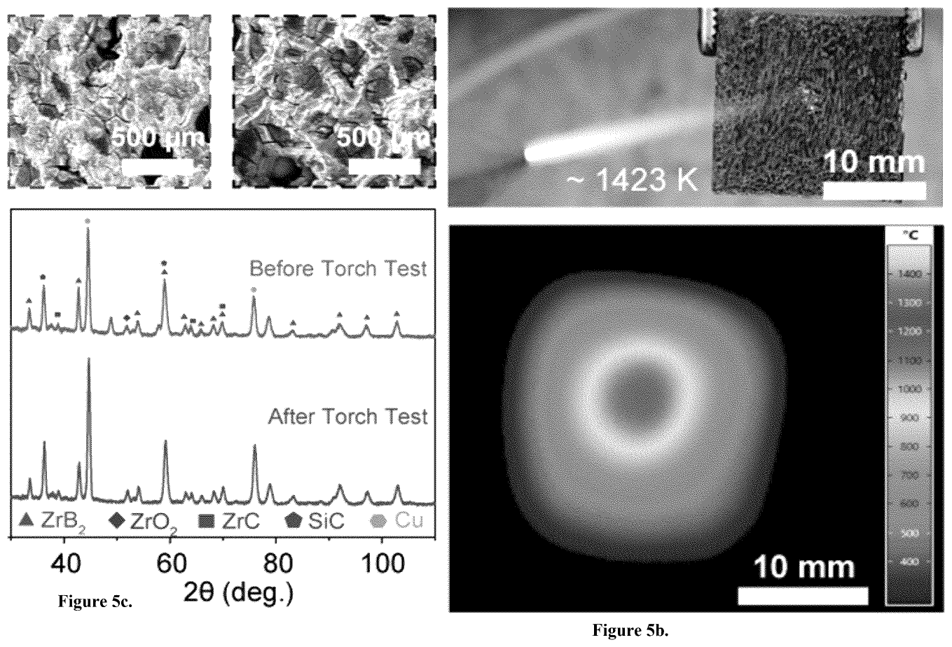

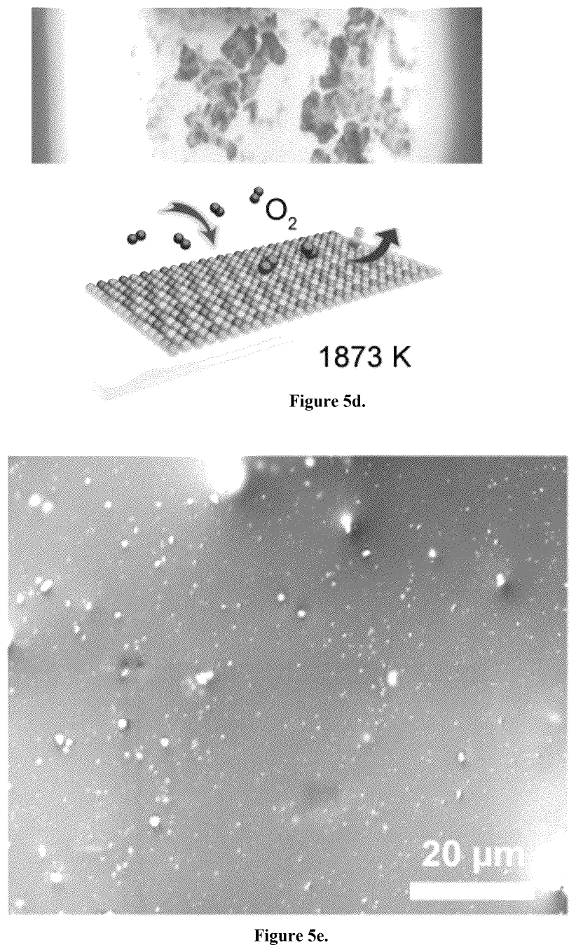

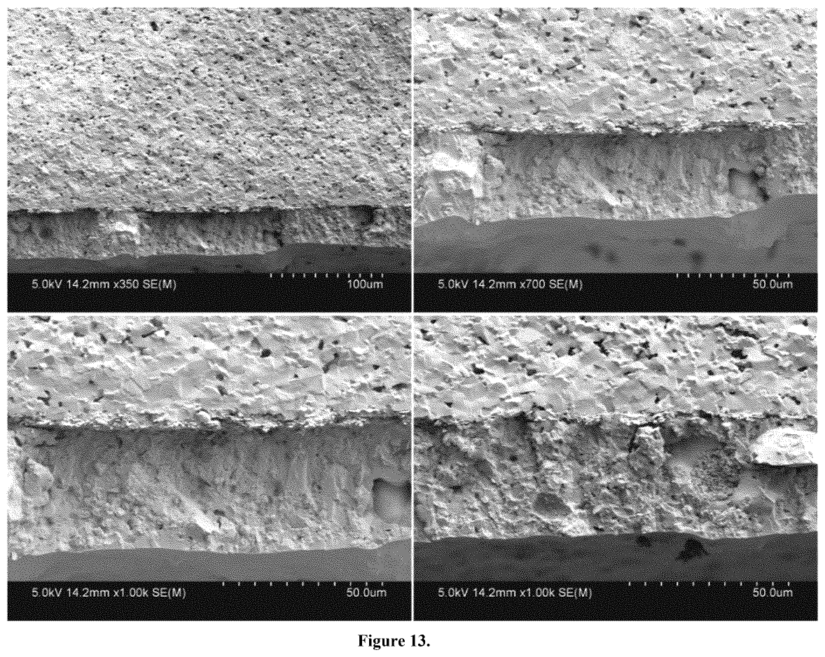

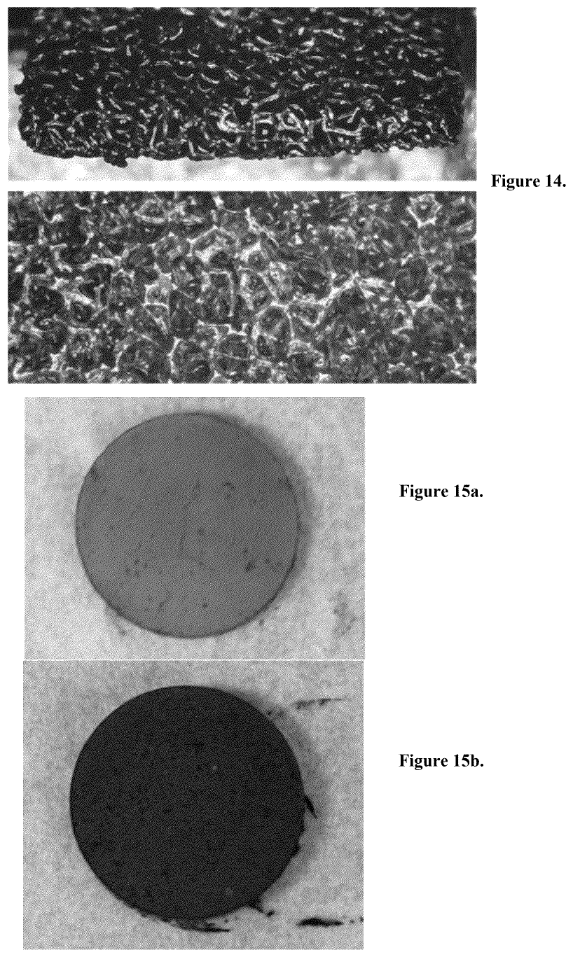

Taking into consideration the liquid nature of the printable preceramic slurry coupled with the swift and adaptive capability of the electrical pyrolysis process, the coating conformability was evaluated onto different copper geometries and tantalum metal foil for this work. FIG. 5a shows the optical images depicting the conformability of the preceramic precursor on 1D, 2D and 3D geometries, corroborating its processing versatility in terms of geometrical intricacy, with the optical images of the plane (non-coated) and isometric views (coated with preceramic slurry and electrically pyrolyzed) presented in FIG. 14. Additionally, the preceramic feedstock can be compacted and pyrolyzed to obtain bulk monolithic samples, and the optical image of the bulk monolithic pellet prepared via compacting preceramic feedstock followed by electrical pyrolysis is presented in FIG. 15. FIG. 5b (top) shows an optical image of the ceramic coating-copper foam being subjected to the oxygen-hydrogen flame to examine its oxidation resistance. The formed ceramic coating prevents oxygen molecules from diffusing inwards towards the metallic (copper) layer. FIG. 5b (bottom) shows the infrared image of the ceramic-copper foam under the influence of the oxygen-hydrogen torch, reaching temperatures above 1423 K. FIG. 5c (top) shows the SEM images of the Cu-foam before and after torch tests, with no visible morphological changes to the surface. To further elucidate the robustness of this material for thermal management, an Ashby plot consisting of operating temperature vs. coating thickness was compiled. From the plot, it can be inferred that the ceramic synthesized in this work displays robust performance at higher operating temperatures. Furthermore, the formed ceramics are exposed to high temperatures (1073-1773 K) to determine any phase changes and confirm its thermal stability. FIG. 5c (bottom) shows the XRD plot of Zr—Si—O—C—B before and after exposure to elevated temperatures, confirming its high-temperature reliability withstanding elevated temperatures (>1273 K) and exhibits no signs of degradation or oxidation. Furthermore, ceramic coatings with different transition elements were also evaluated for the oxidation stability, and the results are compiled in Table 2.

TABLE 2
Torch testing results for ceramics with different crosslinked metals.

| Crosslinking | | |
|---|---|---|
| element | Rᵢₙᵢₜᵢₐₗ | R_{final} |
| Hf | 1.79 Ω (296.1 K) | 6.37 kΩ (1258.1 K) |
| V | 0.81 Ω (296.3 K) | 1.55 kΩ (1337.1 K) |
| Cr | 0.84 Ω (297.4 K) | 1.40 Ω (1322.1 K) |
| Mo | 0.92 Ω (295 K) | 3.15 Ω (1313.1 K) |
| W | 0.73 Ω (295.6 K) | 0.77 Ω (1309.1 K) |

From the results, the Cr, Mo and W samples perform considerably well, with an average resistance change of 5% for the ceramic formed using tungsten (W) as the transition element. For evaluation of oxidation stability of the ceramic at higher temperatures (>1423 K), FIG. 5d (top) shows the scheme illustrating the Zr—Si—O—C—B coated on the tantalum foil as a demonstration. FIG. 5d (bottom) illustrates the working mechanism depicting the ceramic layer functioning as a diffusion barrier to oxygen molecules, thus preventing oxidation of the ceramic as well as the underlying metal layer. FIG. 5e shows the SEM observation of the ceramic layer on tantalum foil exposed to a temperature of 1873 K for a duration of five minutes under atmospheric conditions. The sample was inserted at the set temperature for varying durations, and no visible morphological changes can be observed on the surface, pertaining to phase separation or erosion/oxidation due to elevated temperatures after five minutes. FIG. 5f shows the EDS mapping of the sample exposed for a duration of 5 (top) and 30 minutes (bottom) respectively, at 1873 K, and it can be inferred that the ceramic film maintains its homogeneity and displays no phase separation or oxidation, thus corroborating the robust nature of the compositionally complex ceramics developed in this work. The bulk pellet samples were also evaluated for their oxidation stability by exposing to a temperature of 1273 K for varying durations (1, 10, 30 and 60 minutes, respectively) under oxidative atmospheric conditions. Following the high temperature exposure, the samples were cross sectioned for SEM and EDS characterization. The bulk Zr—Si—O—C—B pellet does not show the oxidation and no phase separation observed.

### Example 3. Preceramic Polymer Precursor Preparation

Zirconium (IV) chloride (or Hafnium (IV) Chloride, Vanadium (III) chloride, Chromium (III) chloride, Molybdenum trioxide or Tungstosilicic acid hydrate) was mixed with Poly(dimethylsilane) in varying ratios (1:1, 2:1, 3:1, 4:1 and 5:1 with the left value representing weight of poly(dimethylsilane) and the right value representing weight of zirconium (IV) chloride) and processed at a temperature of 743 K in a tube furnace under nitrogen environment with a ramping rate of 5° C./min and allowing natural cooling, to enable conversion of poly(dimethylsilane) to polycarbosilane and crosslinking of the metal-polymer chain. Subsequently, the obtained feedstock was further mixed with zirconium diboride (or Hafnium Diboride, Tantalum Carbide, Niobium Carbide and Titanium Diboride) powder in varying ratios (for high throughput testing) and sintered at different temperatures (1373-1773K) in a tube furnace under nitrogen environment with a ramping rate of 5° C./min and followed by natural cooling to obtain the final feedstock powder for further processing.

### Example 4. Printing/Coating of Precursor Slurry and Electrical Pyrolysis (Copper and Tantalum as Substrates)

Following sintering of the compositionally complex ceramic powder, the powder was ground to finer particles and a solvent (StarPCS® SMP-10 polymer) was added in different ratios and the resulting slurry was printed onto the alumina substrate coated with copper nanoplates prior. Keithley 2260B-80-40 DC power supply was used for electrical pyrolysis for pyrolysis (for conversion of preceramic precursor to ceramic) of the samples in atmospheric conditions via variation in the power supplied, which varied the temperature. For pyrolysis of the tantalum foil sample, the Gleeble 563 Thermal Mechanical Simulator was employed. The system was environmentally controlled, through 3× cycles of roughing vacuuming and ultra-high purity argon purge. 0.150 mm thick Ta foil was used as the substrate, held in place by water-cooled Cu grips, and used a dual-color pyrometer for temperature control. The sample was heated from 273-1773 K in <40 seconds, with a holding time of ˜ 30 seconds, and then allowed to cool naturally.

### Example 5. Testing and Characterization

The electrical readings were characterized using Keithley 2450 Sourcemeter with an oxygen-hydrogen gas flame generator as the heating source and platinum wires as electrodes. High temperature steady-state testing was conducted in a tube furnace (1700° C. Tube furnace, TCH Instruments). SEM characterization was carried out via Hitachi SU-70 Scanning Electron Microscope. XRD was performed via Thermo-Fisher ARL Equinox 100 XRD. TEM/STEM and EDS characterizations were carried out using a JEOL JEM-2100F Transmission Electron Microscope equipped with a Bruker Quantax XflashR6 EDS detector operating at 200 kV acceleration voltage.

### Example 6. Conclusion

Herein, is presented a methodology for synthesizing preceramic monomer capable of crosslinking Group IV-VI transition metals (including Zr, Cr, V, Mo, Hf, W, and Nb), enabling the formation of compositionally complex ultrahigh-temperature ceramics. This approach integrates additive manufacturing with electrified pyrolysis, achieving rapid, pressure-free conversion of preceramic materials into dense ceramics at 1073 K in ambient air within 1 minute. This process supports the incorporation of diverse elements into the preceramic network, resulting in ceramics with tailored compositions and minimal shrinkage or porosity upon pyrolysis. The pyrolyzed ceramics exhibit a dense microstructure and contain multiple phases. The presence of these distinct phases contributes to a synergistic enhancement of the material's stability and reliability under high-temperature conditions. The 1D, 2D, and 3D metallic architectures coated with these ceramic layers demonstrate exceptional thermal management capabilities, maintaining high temperature structural integrity. Moreover, the ability to apply the preceramic coating uniformly to various conductive surfaces allows for the formation of protective ceramic layers that effectively shield metals from oxidation even at temperatures as high as 1873 K. This method provides a pathway for producing ceramics with complex transition metal compositions, as well as enabling the creation of bulk monoliths and coatings. It opens new avenues for the development of advanced ceramic materials suited for aerospace, energy, and defense applications, where thermal stability and durability are paramount.

The complete disclosures of the patent, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

We claim:

1. A preceramic short chain polymer of Formula I: 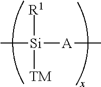
wherein
A is CH₂, NR₂, CR₂, where R is H, alkyl.
R¹ is independently hydrogen, alkyl, or ethyl;
TM is a Group IV, V, or V transition metal; and
x is 1-100.

2. The preceramic short chain polymer of claim 1, wherein said transition metal is titanium, vanadium, chromium, zirconium, niobium, molybdenum, hafnium, tantalum, and tungsten.

3. The preceramic short chain polymer of claim 1, wherein said transition metal is in the form of a transitional metal salt.

4. The preceramic short chain polymer of claim 3, wherein said transition metal salt is zirconium (IV) halide, molybdenum (III) oxide, tungstosilicic acid hydrate, hafnium (IV) halide, or vanadium (III) halide.

5. A preceramic short chain polymer comprising a monomer of Formula I: 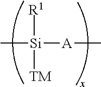
wherein
A is CH₂, NR₂, CR₂, where R is H, alkyl.
R¹ is independently hydrogen, alkyl, or ethyl;
TM is a Group IV, V, or V transition metal; and
x is 1-100.

6. The preceramic short chain polymer of claim 5, wherein said transition metal is titanium, vanadium, chromium, zirconium, niobium, molybdenum, hafnium, tantalum, and tungsten.

7. The preceramic short chain polymer of claim 5, wherein said transition metal is in the form of a transitional metal salt.

8. The preceramic short chain polymer of claim 7, wherein said transition metal salt is zirconium (IV) halide, molybdenum (III) oxide, tungstosilicic acid hydrate, hafnium (IV) halide, or vanadium (III) halide.

9. A preceramic composition comprising a preceramic monomer of Formula I.

10. A preceramic composition comprising a preceramic polymer comprising a monomer of Formula I: 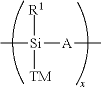
wherein
A is CH₂, NR₂, CR₂, where R is H, alkyl.
R¹ is independently hydrogen, alkyl, or ethyl;
TM is a Group IV, V, or V transition metal; and
x is 1-100.

11. The composition according to claim 10, wherein said composition further comprises a filler.

12. The composition of claim 11, wherein said filler is an inorganic particle.

13. The composition of claim 11, wherein said filler is a ceramic or metal particle solid.

14. The composition of claim 13, wherein said ceramic or metal particle solid is chosen from carbides, borides, nitrides, niobium particles, or copper particles.

15. The composition of claim 11, wherein said filler is hafnium diboride (HfB₂), tantalum carbide (TaC), niobium carbide (NbC), or titanium diboride (TiB₂).

16. The composition of claim 10, wherein said composition is in the form of a coating.

17. A method of making a preceramic short chain polymer of Formula I, said method comprising crosslinking a monomer of Formula I′ in the presence of Group IV, V, or V transition metal and heat to obtain a monomer of Formula I; 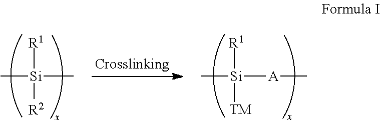
wherein
A is CH₂, NR₂, CR₂, where R is H;
R¹ is independently hydrogen, alkyl, or ethyl;
R² is independently hydrogen, alkyl, or ethyl;
TM is a Group IV, V, or V transition metal; and
where x is 1-100.

18. The method of claim 17, wherein said transition metal is titanium, vanadium, chromium, zirconium, niobium, molybdenum, hafnium, tantalum, and tungsten.

19. The method of claim 17, wherein said transition metal is in the form of a transitional metal salt.

20. The method of claim 19, wherein said transition metal salt is zirconium (IV) halide, molybdenum (III) oxide, tungstosilicic acid hydrate, hafnium (IV) halide, or vanadium (III) halide.
